(19) United States
(12) Patent Application Publication
(10) Pub. No.: US 2013/0332301 A1
(43) Pub. Date: Dec. 12, 2013

(54) METHODS AND SYSTEMS FOR MAKING OFFERS BASED ON CONSUMERS' PRICE DISCRIMINATION

(71) Applicants: Jonathan Kilroy, Champaign, IL (US); Allie K. Watfa, Urbana, IL (US); Dale Nussel, Mahomet, IL (US); Mangesh Pardeshi, Champaign, IL (US)

(72) Inventors: Jonathan Kilroy, Champaign, IL (US); Allie K. Watfa, Urbana, IL (US); Dale Nussel, Mahomet, IL (US); Mangesh Pardeshi, Champaign, IL (US)

(73) Assignee: Yahoo! Inc., Sunnyvale, CA (US)

(21) Appl. No.: 13/490,178

(22) Filed: Jun. 6, 2012

(51) Int. Cl. G06Q 30/06

(52) U.S. Cl. 705/26.4

(57) ABSTRACT

Techniques are provided which allow users to view historical price information for a product, and which allow users to specify a desired purchase price. Historical price information may be collected and displayed to the user in a graphical format. The user may specify a desired purchase price that the user is willing to pay for the product. The user provided price may be presented to a seller of the product. The user may be targeted with an offer to purchase the product at the user provided price or may be targeted with advertisements or recommendations for a similar product. Some techniques include targeting a group of users including the user with the offer if the group of users includes at least a predetermined number of users, where each user in the group provided the user provided price.

### BACKGROUND

With the advent of broadband internet, online shopping has grown in popularity. Traditionally, it is the seller's job to attract buyers and then to complete the sale. Most goods and services sold at retail are done so using a general seller-driven protocol whereby the seller sets a price and the buyer decides whether or not to accept that price. Prices for some goods and services might change frequently, but the buyer must still wait for the seller to offer a price he finds acceptable.

In addition, online shoppers typically search for the best price for the product they're interested in purchasing. Typically, online shoppers will be more likely to purchase a product if it is priced at its average or below average price.

Accordingly, there is a need for a buyer-driven system capable of being utilized by consumers to communicate their purchasing needs to potential sellers.

### SUMMARY

Some embodiments of the invention provide systems and methods which provide online shoppers with historical pricing information for a product, and allow shoppers to specify a desired purchase price for a product. Historical price information may be collected for a product from one or more of a new product source, a used product source and a refurbished product source. The historical price information may include, for example a new product price, a used product price, and a refurbished product price over a predetermined time period (e.g., last six months). The price information may be obtained from a manufacturer of the product. Alternatively, or in addition, price information may be obtained from retailers or third party sellers such as Amazon®, ebay®, Craigslist®, etc. It will be understood that a used price refers to the price of a used product that is being sold by a private party (e.g., an individual). By contrast, the refurbished price refers to the price of a product that has been restored for sale by a manufacturer of the product according to certain standards as determined by the manufacturer. In some embodiments, the price information may include the maximum price the product has sold for, the minimum price the product has sold for, the average price over a specified time period, etc. In some embodiments, the price information may also include other information related to the product, such as for example, review information. The review information may include an average review rating based on review ratings that the product has accumulated over a predetermined period of time. The review ratings may be obtained from retailers such as for example, ebay® or Amazon®.

The price information may be displayed in a graphical format to a user in response to the user visiting a website, wherein the product is offered for sale for a listed price on the website. For example, when the user visits a website which has the product listed for sale at a certain listed price, the user may be presented with the historical price information for the product. The historical price information may be presented to the user in various ways, such as, a line graph, a pie graph, etc. The historical price information may be for example the price of the product over the last six months. In some embodiments, the user may be allowed to specify the desired time period on the website. For example, the user may specify whether he wants to view the historical price information over the last six months or over the last year. The historical price information may also include prices for the product in various conditions, such as, new, used, refurbished, etc. This may allow the user to make a decision on whether the present time is a good time to purchase the product by comparing the listed price with the historical price information.

If for instance, the user decides based on the historical price information that the current listed price is too high, the user may specify a price for the product. A user provided price that the user is willing to pay for the product may be accepted on the website, wherein the user provided price is different from the listed price. The user may provide the desired price in for example, an input field on the website. The user provided price may be presented to a seller of the product. The seller may include the manufacturer of the product, or may be a third party retailer or re-seller (e.g., Amazon). The seller may be presented with user provided prices from a plurality of users. For example the seller may be provided with information indicating the number of users who would like to purchase the product at various price points (e.g., 100 users would purchase the product at a $50 discount, 200 users would purchase the product at a $100 discount, etc.). The user provided price information may be presented to the seller in various formats, such as line graph, pie graph, etc.

The user may be targeted with an offer to purchase the product at the user provided price. In some embodiments, a group of users may be targeted with offers to purchase the price at the user provided price, wherein each of the users in the group of users previously specified that they would purchase the product at the user provided price. For example, if 50 users indicated that they would purchase the product at a $50 discount, and 100 users indicated that they would purchase the product at a $100 discount, the group of 100 users may be targeted with offers to purchase the product at a $100 discount. Alternatively, or in addition, in some embodiments, one or more users may be targeted with advertisements or provided with recommendations for a similar product that is within their preferred price range. For example, if the user is interested in purchasing a Canon 5D camera, and the user specifies that the user would like to purchase the camera for $500, the seller may provide a recommendation to the user for a different camera that is within the user's $500 price range. The price range may be determined based on a predetermined percentage within the user provided price (e.g., ±5% of the user provided price). The determination of whether to target the user with advertisements or provide the user with recommendations for a similar product may be made based on for example, how “far off” the user provided price is from the listed price. For example, if the user provided price is less than a predetermined percentage from the listed price, then the user may be provided with advertisements or recommendations for a similar product in the user's price range. For example, if the user provided price is less than 85% of the listed price (e.g., more than a 15% discount), then the user may be provided with advertisements or recommendations for a similar product.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

### DETAILED DESCRIPTION

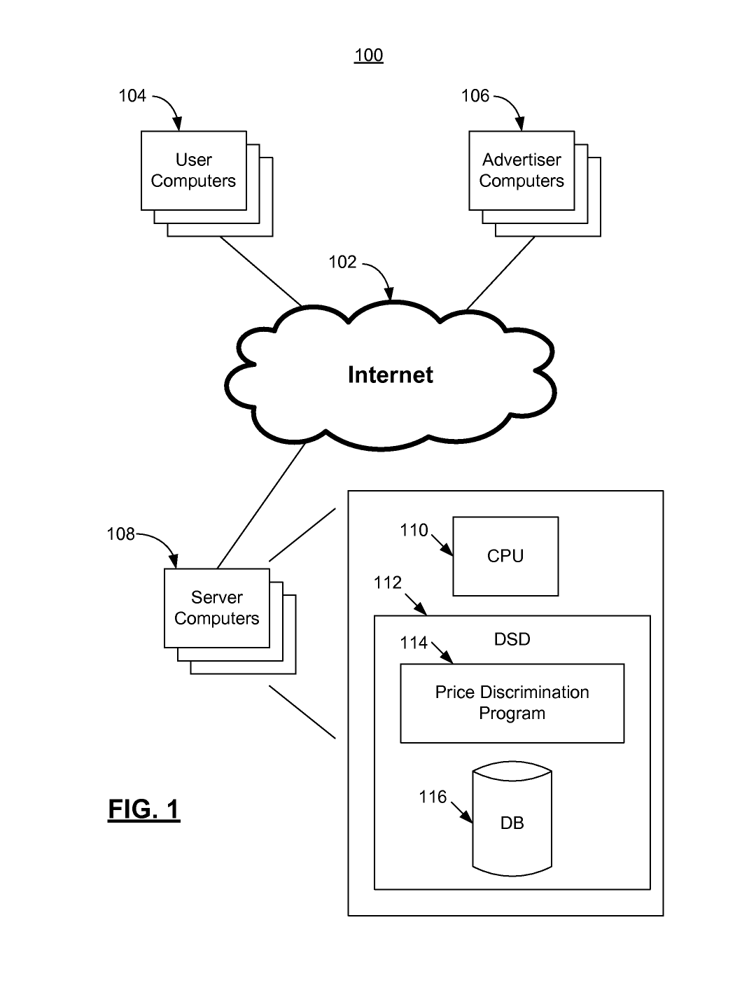

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Price Discrimination Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

Embodiments of the invention provide online shoppers with historical pricing information for a product and, allow shoppers to specify a desired price for the product. Online shoppers visit online stores like Amazon.com or buy.com with the intention to buy a product and they may not make a purchase because of the inability to know if the product they are buying is a “bad deal”, “OK deal”, “good deal” or an “excellent deal”. At any point in time, there are sets of consumers that: are looking to buy new as soon as possible if they are getting a reasonable deal, are looking for the best deal and willing to wait for it, want to buy but would consider buying the item used, and want to buy but plan to resell the used item later, as it only has limited use time for them.

Embodiments of the invention will present shoppers with a product's historical price information. In addition, the current reseller price (e.g., used price) for the item may be shown to help the buyer understand if they could recoup a portion of their cost by reselling or buying a used version of the item. If a group or cluster of consumers is large enough to impact the price of the product for that specific group, then this may cause the manufacturer or seller to lower the price for the group.

A system in accordance with embodiments of the invention may search for products and prices in a given timeline rather than at a single one point in time. By seeing the timeline, the consumer will understand instantly if the product price is increasing, decreasing or somewhat fixed. The system may fetch/capture in time, information that current consumers have no easy access to and display it to them in an organized format. The price history may include new prices, used prices and refurbished prices. This data will also be critical to understand how much an item will resell for once bought. By showing the entire picture of an item's price history, potential buyers may indicate to manufacturers and/or sellers their interest in the products and be satisfied that they got a good deal on the purchase price.

Embodiments of the invention may allow potential customers the option to put in a “buy order” at a certain price. For example, a consumer may indicate that they would buy the product if it was priced at $X. A price trend chart which indicates the number of consumers waiting for a certain price point, may help a manufacturer plan its manufacturing operations to achieve a reasonable discounted price. This additionally may allow an isolated consumer to see where other isolated consumers would buy at and choose to join them to improve their chances of getting the discount. The manufacturer and/or seller will be able to see the concentration of potential buyers at certain price points. If the manufacturer and/or seller agree to sell at the price desired by a group of users, they can use the system to notify interested buyers and formally setup orders.

In some embodiments, a potential buyer may get notified when the manufacturer and/or seller meets the demand of a group of potential buyers interested in a particular price range for a particular product.

In some embodiments, potential buyers may be served ads and/or recommendations for the same or related products. In some embodiments, manufacturers and/or sellers may advantageously be able to determine buyer interest in a product and hence may offer more incentives for the product, understand the price range and hence trigger an adjustment in their prices, gain information on where the interest is coming from and hence use that information to target potential buyers.

In some embodiments, a periodic search may be conducted (e.g., once a week) to search for products and prices. The search may eliminate (e.g., if a product is discontinued) or add a product (e.g., if a new product is added), and may capture a change in price of a product. The captured data may be stored in for example, cloud storage and may be updated to include data detailing products and their properties that has been captured with the periodic search.

As will be apparent to one of ordinary skill in the art, cloud storage is a model of networked online storage where data is stored on virtualized pools of storage. The data center operators virtualize the resources according to the requirements of the customer and expose them as storage pools, which the customers can themselves use to store files or data objects. Physically, the resources may span across multiple servers. In some embodiments, cloud computing may also be used to capture the data.

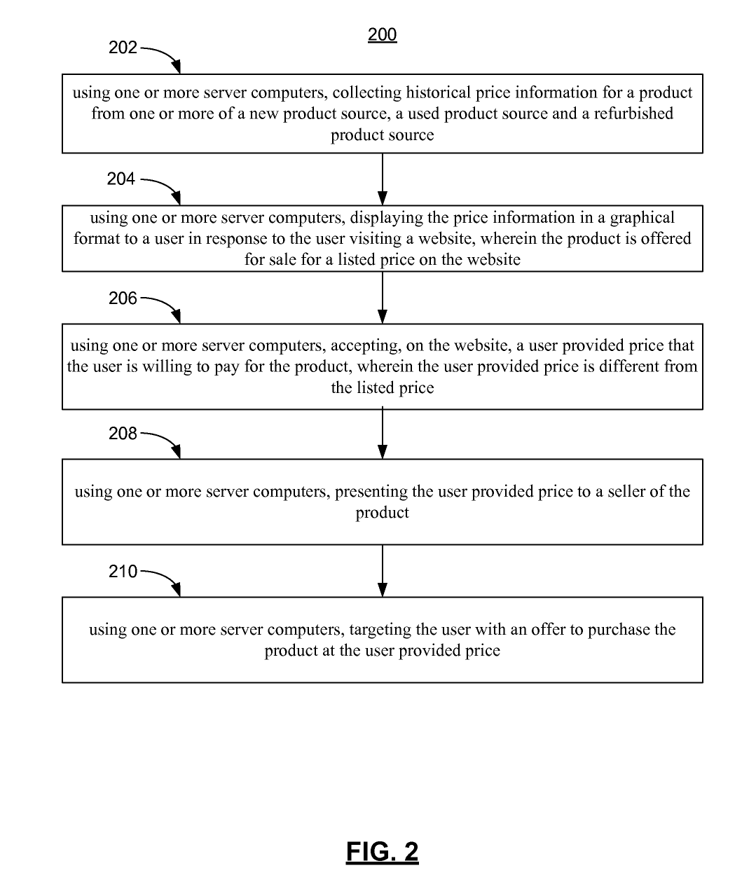

FIG. 2 is a flow diagram illustrating a method 200 according to one embodiment of the invention. At step 202, using one or more server computers, historical price information may be collected for a product from one or more of a new product source, a used product source and a refurbished product source. The historical price information may include, for example a new product price, a used product price, and a refurbished product price over a predetermined time period (e.g., last six months). The price information may be obtained from a manufacturer of the product. Alternatively, or in addition, price information may be obtained from retailers or third party sellers such as Amazon®, ebay®, Craigslist®, etc. It will be understood that a used price refers to the price of a used product that is being sold by a private party (e.g., an individual). By contrast, the refurbished price refers to the price of a product that has been restored for sale by a manufacturer of the product according to certain standards as may be determined by the manufacturer. In some embodiments, the price information may include the maximum price the product has sold for, the minimum price the product has sold for, the average price over a specified time period, etc. In some embodiments, the price information may also include other information related to the product, such as for example, review information. The review information may include an average review rating based on review ratings that the product has accumulated over a predetermined period of time. The review ratings may be obtained from retailers such as for example, ebay® or Amazon®.

At step 204, using one or more server computers, the price information may be displayed in a graphical format to a user in response to the user visiting a website, wherein the product is offered for sale for a listed price on the website. For example, when the user visits a website which has the product listed for sale at a certain listed price, the user may be presented with the historical price information for the product. The historical price information may be presented to the user in various ways, such as, a line graph, a pie graph, etc. The historical price information may be for example the price of the product over the last six months. In some embodiments, the user may be allowed to specify the desired time period on the website. For example, the user may specify whether he wants to view the historical price information over the last six months or over the last year. The historical price information may also include prices for the product in various conditions, such as, new, used, refurbished, etc. This may allow the user to make a decision on whether the present time is a good time to purchase the product by comparing the listed price with the historical price information.

If for instance, the user decides based on the historical price information that the current listed price is too high, the user may specify a price for the product. At step 206, using one or more server computers, a user provided price that the user is willing to pay for the product may be accepted on the website, wherein the user provided price is different from the listed price. The user may provide the desired price in for example, an input field on the website. At step 208, using one or more server computers, the user provided price may be presented to a seller of the product. The seller may include the manufacturer of the product, or may be a third party retailer or re-seller (e.g., Amazon). The seller may be presented with user provided prices from a plurality of users. For example the seller may be provided with information indicating the number of users who would like to purchase the product at various price points (e.g., 100 users would purchase the product at a $50 discount, 200 users would purchase the product at a $100 discount, etc.). The user provided price information may be presented to the seller in various formats, such as line graph, pie graph, etc. In some embodiments, the user provided price information may also be presented to the user. This may allow the user to determine what price to specify. For example, if the user sees that 100 users would purchase the product at a $100 discount, and 50 users would purchase the product at a $125 discount, the user may choose to join the group of 100 users who would purchase the product at a $100 discount, as this may increase the user's chances of being able to purchase the product at that price.

At step 210, using one or more server computers, the user may be targeted with an offer to purchase the product at the user provided price. In some embodiments, a group of users may be targeted with offers to purchase the price at the user provided price, wherein each of the users in the group of users previously specified that they would purchase the product at the user provided price. For example, if 50 users indicated that they would purchase the product at a $50 discount, and 25 users indicated that they would purchase the product at a $100 discount, the group of 50 users may be targeted with offers to purchase the product at a $50 discount. Alternatively, or in addition, in some embodiments, one or more users may be targeted with advertisements or provided with recommendations for a similar product that is within their preferred price range. For example, if the user is interested in purchasing a Canon 5D camera, and the user specifies that the user would like to purchase the camera for $500, the seller may provide a recommendation to the user for a different camera that is within the user's $500 price range. The price range may be determined based on a predetermined percentage within the user provided price (e.g., ±5% of the user provided price). The determination of whether to target the user with advertisements or provide the user with recommendations for a similar product may be made based on for example, how “far off” the user provided price is from the listed price. For example, if the user provided price is less than a predetermined percentage from the listed price, then the user may be provided with advertisements or recommendations for a similar product in the user's price range. For example, if the user provided price is less than 85% of the listed price (e.g., more than a 15% discount), then the user may be provided with advertisements or recommendations for a similar product.

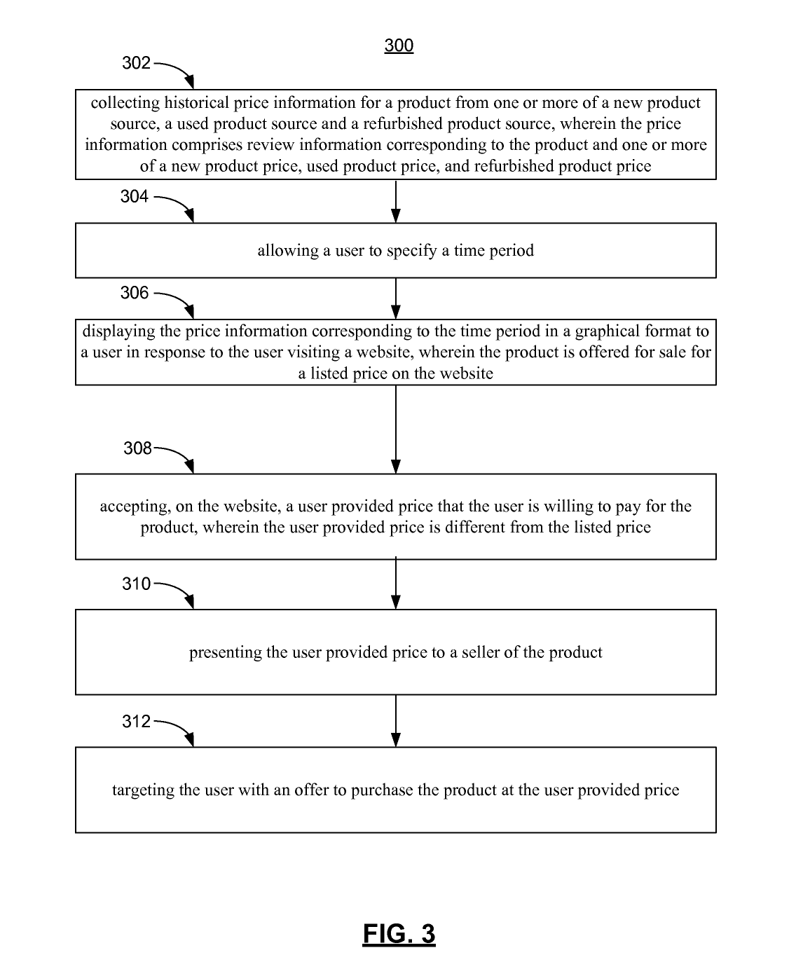

FIG. 3 is a flow diagram illustrating a method 300 according to one embodiment of the invention. At step 302, using one or more server computers, historical price information may be collected for a product from one or more of a new product source, a used product source and a refurbished product source, wherein the price information comprises review information corresponding to the product and one or more of a new product price, used product price, and refurbished product price. The historical price information may include, for example a new product price, a used product price, and a refurbished product price over a predetermined time period (e.g., last six months). The price information may be obtained from a manufacturer of the product. Alternatively, or in addition, price information may be obtained from retailers or third party sellers such as Amazon®, ebay®, Craigslist®, etc. It will be understood that a used price refers to the price of a used product that is being sold by a private party (e.g., an individual). By contrast, the refurbished price refers to the price of a product that has been restored for sale by a manufacturer of the product according to certain standards as may be determined by the manufacturer. In some embodiments, the price information may include the maximum price the product has sold for, the minimum price the product has sold for, the average price over a specified time period, etc. The review information may include an average review rating based on review ratings that the product has accumulated over a predetermined period of time. The review ratings may be obtained from retailers such as for example, ebay® or Amazon®.

At step 304, the user may specify a time period. The time period may be specified by the user using for example an input field on a website. At step 306, using one or more server computers, the price information corresponding to the time period may be displayed in a graphical format to a user in response to the user visiting a website, wherein the product is offered for sale for a listed price on the website. For example, when the user visits a website which has the product listed for sale at a certain listed price, the user may be presented with the historical price information for the product. The historical price information corresponding to the user specified time period may be presented to the user in various ways, such as, a line graph, a pie graph, etc. The historical price information may be for example the price of the product over the last six months. The historical price information may also include prices for the product in various conditions, such as, new, used, refurbished, etc. This may allow the user to make a decision on whether the present time is a good time to purchase the product by comparing the listed price with the historical price information.

If for instance, the user decides based on the historical price information that the current listed price is too high, the user may specify a price for the product. At step 308, using one or more server computers, a user provided price that the user is willing to pay for the product may be accepted on the website, wherein the user provided price is different from the listed price. The user may provide the desired price in for example, an input field on the website. At step 310, using one or more server computers, the user provided price may be presented to a seller of the product. The seller may include the manufacturer of the product, or may be a third party retailer or re-seller (e.g., Amazon). The seller may be presented with user provided prices from a plurality of users. For example the seller may be provided with information indicating the number of users who would like to purchase the product at various price points (e.g., 100 users would purchase the product at a $50 discount, 200 users would purchase the product at a $100 discount, etc.). The user provided price information may be presented to the seller in various formats, such as line graph, pie graph, etc.

At step 312, using one or more server computers, the user may be targeted with an offer to purchase the product at the user provided price. In some embodiments, a group of users may be targeted with offers to purchase the price at the user provided price, wherein each of the users in the group of users previously specified that they would purchase the product at the user provided price. For example, if 50 users indicated that they would purchase the product at a $50 discount, and 25 users indicated that they would purchase the product at a $100 discount, the group of 25 users may be targeted with offers to purchase the product at a $50 discount. Alternatively, or in addition, in some embodiments, one or more users may be targeted with advertisements or provided with recommendations for a similar product that is within their preferred price range. For example, if the user is interested in purchasing a Canon 5D camera, and the user specifies that the user would like to purchase the camera for $500, the seller may provide a recommendation to the user for a different camera that is within the user's $500 price range. The price range may be determined based on a predetermined percentage within the user provided price (e.g., ±5% of the user provided price). The determination of whether to target the user with advertisements or provide the user with recommendations for a similar product may be made based on for example, how “far off” the user provided price is from the listed price. For example, if the user provided price is less than a predetermined percentage from the listed price, then the user may be provided with advertisements or recommendations for a similar product in the user's price range. For example, if the user provided price is less than 85% of the listed price (e.g., more than a 15% discount), then the user may be provided with advertisements or recommendations for a similar product.

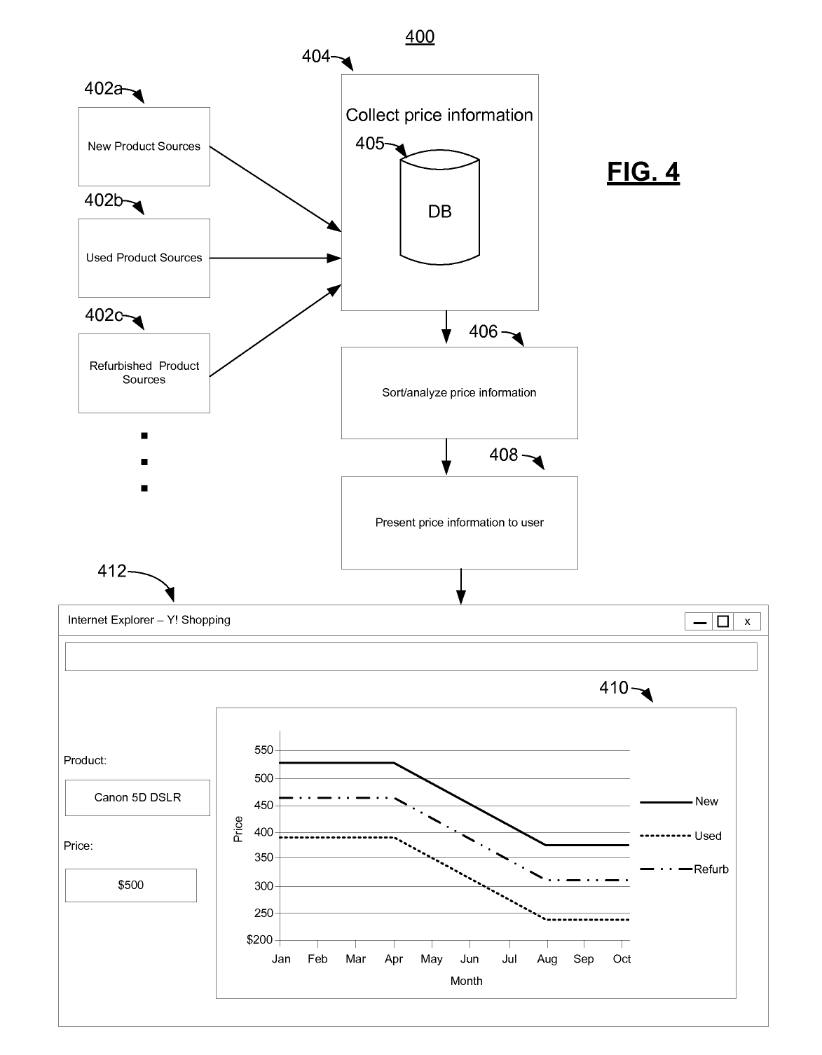

FIG. 4 is a block diagram 400 according to one embodiment of the invention. One or more data stores or databases 405 are depicted. Various types of information are stored in the database 405. In particular, types of depicted information stored in the database 405 include, potentially among many other types of information, historical price information, which may include a maximum price that a product has sold for, a minimum price that a product has sold for, average price of the product over a certain time period, etc. The various different prices may be obtained for a product in various conditions, such as new condition, used condition, refurbished condition, etc. In addition, the price information may also include other types of information such as for example, review information corresponding to a product. The review information may include for example, average review rating for a product over a certain time period. The information stored in database 405 may be obtained, gathered, or generated in various ways from various sources such as new product sources 402a, used product sources 402b, refurbished sources 402c. New, used and refurbished product sources may include, for example, one or more of a manufacturer of the product, or retailers or third party sellers such as Amazon®, ebay®, Craigslist®, etc.

As depicted in block 404, the price information may be obtained and stored in database 405. As will be apparent to one of ordinary skill in the art, database 405 may be part of a server or distributed storage (e.g., cloud storage). The collected price information may be sorted and/or analyzed as depicted in block 406, and presented to the user as depicted in block 408. The price information may be presented to the user in a graphical format as shown in screenshot 412. Screenshot 412 depicts a website where the user may purchase the product. Upon visiting the website, the user may be presented with historical price information graph 410. In some embodiments, the user may specify a time period for which the user desires historical price information (e.g., last six months). If the user specifies the time period, historical price information graph 410 may be updated to display the user specified time period. Historical price information graph 410 may also include prices for the product in various conditions, such as, new, used, refurbished, etc. This may allow the user to make a decision on whether the present time is a good time to purchase the product by comparing the listed price with the historical price information. In addition, the user may determine at what price the product may later be resold by for example, analyzing how the used product price has changed over time.

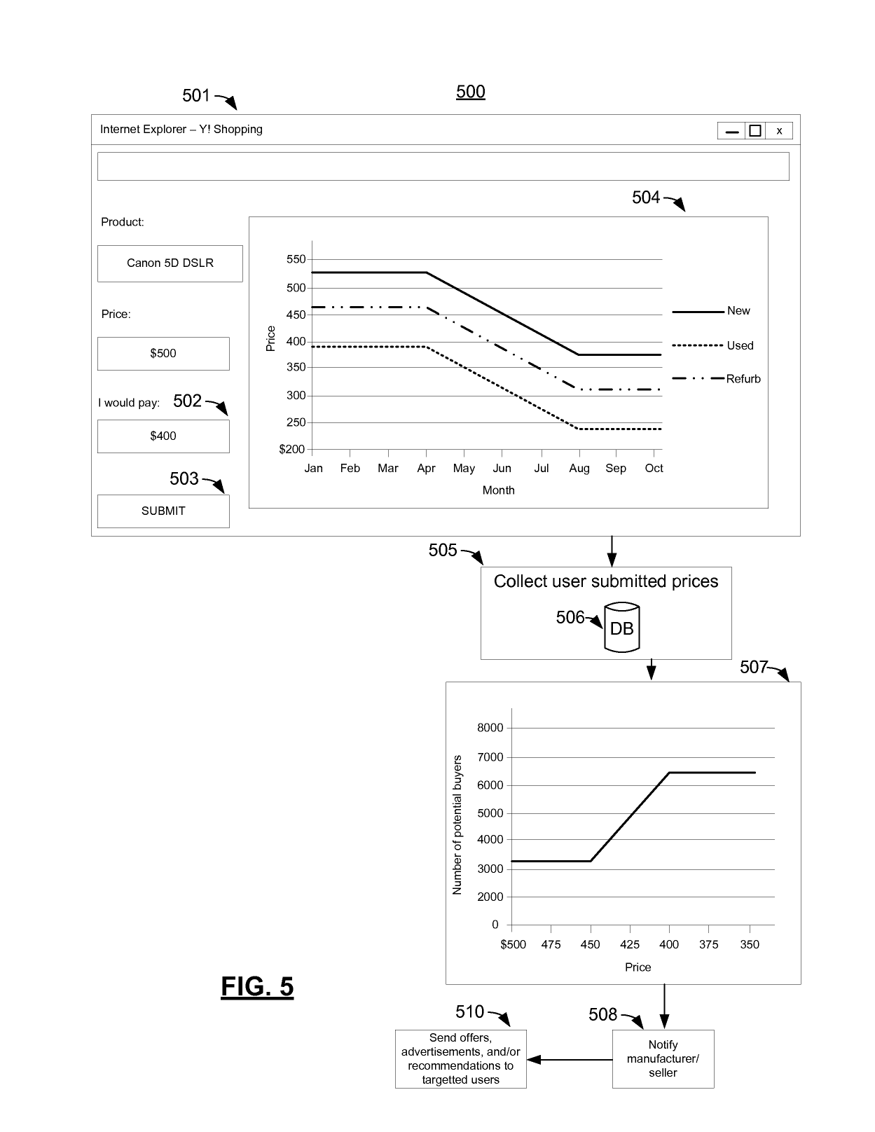

FIG. 5 is a block diagram 500 illustrating one embodiment of the invention. A screenshot 501 of a website in accordance with one embodiment of the invention is depicted. If for instance, the user decides based on historical price information graph 504 that the current listed price is too high, the user may specify a price for the product. The user may specify a price using for example input field 502 and by clicking submit button 503. As depicted in block 505, the user provided or submitted prices may be collected and stored in database 506. The user provided prices may be sent to manufacturers and/or sellers as depicted in block 508. In one example, the user provided prices may be presented to manufacturers and/or sellers as shown in graph 507. The prices may be presented in various other formats, such as pie graphs, bar graphs, etc. The sellers may include a third party retailer or re-seller (e.g., Amazon). The manufacturer and/or seller may be presented with user provided prices from a plurality of users. For example the seller may be provided with information indicating the number of users who would like to purchase the product at various price points (e.g., 100 users would purchase the product at a $50 discount, 200 users would purchase the product at a $100 discount, etc.).

As shown in block 510, the user(s) may be targeted with offers to purchase the product at the user provided price, advertisements and/or recommendations for similar products. In some embodiments, a group of users may be targeted with offers to purchase the price at the user provided price, wherein each of the users in the group of users previously specified that they would purchase the product at the user provided price. For example, if 50 users indicated that they would purchase the product at a $50 discount, and 25 users indicated that they would purchase the product at a $100 discount, the group of 50 users may be targeted with offers to purchase the product at a $50 discount. Alternatively, or in addition, in some embodiments, one or more users may be targeted with advertisements or provided with recommendations for a similar product that is within their preferred price range. For example, if the user is interested in purchasing a Canon 5D camera, and the user specifies that the user would like to purchase the camera for $500, the seller may provide a recommendation to the user for a different camera that is within the user's $500 price range. The price range may be determined based on a predetermined percentage within the user provided price (e.g., ±5% of the user provided price). The determination of whether to target the user with advertisements or provide the user with recommendations for a similar product may be made based on for example, how “far off” the user provided price is from the listed price. For example, if the user provided price is less than a predetermined percentage from the listed price, then the user may be provided with advertisements or recommendations for a similar product in the user's price range. For example, if the user provided price is less than 85% of the listed price (e.g., more than a 15% discount), then the user may be provided with advertisements or recommendations for a similar product.

While the invention is described with reference to the above drawings, the drawings are intended to be illustrative, and the invention contemplates other embodiments within the spirit of the invention.

1. A method comprising:
using one or more server computers, collecting historical price information for a product from one or more of a new product source, a used product source and a refurbished product source;
using one or more server computers, displaying the price information in a graphical format to a user in response to the user visiting a website, wherein the product is offered for sale for a listed price on the website;
using one or more server computers, accepting, on the website, a user provided price that the user is willing to pay for the product, wherein the user provided price is different from the listed price;
using one or more server computers, presenting the user provided price to a seller of the product; and
using one or more server computers, targeting the user with an offer to purchase the product at the user provided price.

2. The method of claim 1, wherein presenting the user provided price to the seller comprises:
presenting the user provided price and prices provided by other users to the seller in a graphical format.

3. The method of claim 1, wherein targeting the user comprises:
targeting a group of users including the user with the offer if the group of users includes at least a predetermined number of users, wherein each user in the group of users provided the user provided price.

4. The method of claim 1, further comprising:
providing to the user a recommendation for a second product, wherein a price of the second product is within a predetermined percentage of the user provided price.

5. The method of claim 1, wherein displaying the price information to the user comprises:
allowing the user to specify a time period; and
displaying the price information corresponding to the time period.

6. The method of claim 1, wherein the price information comprises one or more of new product price, used product price, and refurbished product price.

7. The method of claim 1, wherein the price information comprises review information for the product.

8. The method of claim 7, wherein the review information comprises an average review rating for the product over a predetermined period of time.

9. The method of claim 1, wherein displaying the price information comprises displaying an average price for the product over a predetermined time period.

10. A system comprising:
one or more server computers coupled to a network; and
one or more databases coupled to the one or more server computers;
wherein the one or more server computers are for:
collecting historical price information for a product from one or more of a new product source, a used product source and a refurbished product source;
displaying the price information in a graphical format to a user in response to the user visiting a website, wherein the product is offered for sale for a listed price on the website;
accepting, on the website, a user provided price that the user is willing to pay for the product, wherein the user provided price is different from the listed price;
presenting the user provided price to a seller of the product; and
targeting the user with an offer to purchase the product at the user provided price.

11. The system of claim 10, wherein presenting the user provided price to the seller comprises:
presenting the user provided price and prices provided by other users to the seller in a graphical format.

12. The system of claim 10, wherein targeting the user comprises:
targeting a group of users including the user with the offer if the group of users includes at least a predetermined number of users, wherein each user in the group of users provided the user provided price.

13. The system of claim 10, wherein the server computers are further configured for:
providing to the user a recommendation for a second product, wherein a price of the second product is within a predetermined percentage of the user provided price.

14. The system of claim 10, wherein the server computers are further configured for:
allowing the user to specify a time period; and
displaying the price information corresponding to the time period.

15. The system of claim 10, wherein the price information comprises one or more of a new product price, used product price, and refurbished product price.

16. The system of claim 10, wherein the price information comprises review information for the product.

17. The system of claim 16, wherein the review information comprises an average review rating for the product over a predetermined period of time.

18. The system of claim 10, wherein displaying the price information comprises displaying an average price for the product over a predetermined time period.

19. The system of claim 10, wherein the graphical format is a line graph.

20. A non-transitory computer readable storage medium having stored thereon instructions for causing a computer to execute a method, the method comprising:
collecting historical price information for a product from one or more of a new product source, a used product source and a refurbished product source, wherein the price information comprises review information corresponding to the product and one or more of a new product price, used product price, and refurbished product price;
allowing a user to specify a time period;
displaying the price information corresponding to the time period in a graphical format to the user in response to the user visiting a website, wherein the product is offered for sale for a listed price on the website;
accepting, on the website, a user provided price that the user is willing to pay for the product, wherein the user provided price is different from the listed price;
presenting the user provided price to a seller of the product; and
targeting the user with an offer to purchase the product at the user provided price.
